(19) United States
(12) Patent Application Publication
(10) Pub. No.: US 2024/0337230 A1
(43) Pub. Date: Oct. 10, 2024

(54) INTAKE MANIFOLD AND OUTBOARD MOTOR

(71) Applicant: MIKUNI CORPORATION, Tokyo (JP)

(72) Inventor: Hirobumi OOSAWA, Kanagawa (JP)

(73) Assignee: MIKUNI CORPORATION, Tokyo (JP)

(21) Appl. No.: 18/592,559

(22) Filed: Mar. 1, 2024

(30) Foreign Application Priority Data
Apr. 6, 2023 (JP) 2023-061805

(51) Int. Cl. F02M 35/10; F02M 35/104; F02M 35/16

(52) U.S. Cl. CPC F02M 35/10052; F02M 35/104; F02M 35/167

(57) ABSTRACT

An intake manifold 2 suitable for an engine includes: a surge tank 100, die-molded to temporarily store intake air; and a plurality of branch pipes 211, 212, 213, 311, 312, 313, in communication with the surge tank. The surge tank 100 includes: a boss part 111, having a cylindrical shape; and boss reinforcement ribs 114, extending in a direction toward a center S of the boss part and connected with the boss part, the boss part and the boss reinforcement ribs being integrally formed on an outer wall of the surge tank.

### CROSS-REFERENCE TO RELATED APPLICATION

This application claims the priority benefit of Japan application serial No. 2023-061805, filed on Apr. 6, 2023. The entirety of the above-mentioned patent application is hereby incorporated by reference herein and made a part of this specification.

### BACKGROUND

### Technical Field

The invention relates to an intake manifold suitable for an intake system of an engine, such as an outboard motor, and particularly relates to an intake manifold in which a boss part is die-molded on an outer wall of a surge tank and an outboard motor in which the intake manifold is mounted.

### Description of Related Art

As a conventional intake manifold of an engine for an outboard motor, an intake manifold with a configuration as following is known: a left intake pipe and a left surge tank, disposed on a left outer side of a cylinder block of a V-type multi-cylinder engine and a right intake pipe and a right surge tank, disposed on a right outer side of the cylinder block of the V-type multi-cylinder engine, so as to surround the periphery of the cylinder block; and a throttle body, interposed between the left surge tank and the right surge tank (see, for example, Patent Document 1, Patent Document 2).

Also, as another intake manifold of an engine for an outboard motor, an intake manifold with a configuration as follows is known: a left intake pipe and a left surge tank, disposed on an outer side of a left cylinder head of a V-type multi-cylinder engine and a right intake pipe and a right surge tank, disposed on an outer side of a right cylinder head, so as to surround cylinder heads on both sides of the V-type multi-cylinder engine; and a throttle body, linked to the left surge tank. The left surge tank and the right surge tank are in connection and communication with each other, and multiple fixing parts formed to protrude from outer edge parts of the left surge tank and the right surge tank are provided (see, for example, Patent Document 3).

Moreover, as another intake manifold of an engine for an outboard motor, an intake manifold with a configuration as follows is known: the intake manifold is disposed in a region sandwiched by cylinder heads on both sides of a V-type multi-cylinder engine and includes: multiple intake pipes; a surge tank, formed on an upstream side of the intake ports; and a throttle body (electronically controlled throttle) connected with the surge tank (see, for example, Patent Document 4).

As described above, in the conventional intake manifolds, no other functional components are installed to the outer wall of the surge tank, so a boss part for installation is not provided.

Assuming that various functional components are to be fastened and fixed to the outer wall of the surge tank, it is necessary to provide dedicated boss parts while securing mechanical strength. Therefore, at the time of die-molding a boss part, together with a reinforcement rib for securing the mechanical strength, on the outer wall of the surge tank, there is a concern that a sink mark (indentation, sink hole) may occur due to local shrinkage during cooling after molding when the contact region between the boss part and the reinforcement rib increases. Such sink mark may deform the hole shape of the boss part and deteriorate the accuracy of the dimension. Therefore, in the case of fixing a nut to the boss part through outserting, the nut cannot be fixed firmly, and the reliability in terms of function may be affected.

### PRIOR ART DOCUMENT(S)

### Patent Document

[Patent Document 1] Japanese Laid-open No. 2005-23844
[Patent Document 2] Japanese Laid-open No. 2003-247467
[Patent Document 3] Japanese Laid-open No. 2020-101096
[Patent Document 4] Japanese Laid-open No. 2015-227629

The invention provides an intake manifold and an outboard motor including the intake manifold, which, at the time of integrally forming boss parts and reinforcement ribs through die-molding, are able to prevent a sink mark, etc., from occurring and secure mechanical strength, and are particularly able to firmly fix nuts through outsertion.

### SUMMARY

An intake manifold according to an aspect of the invention is an intake manifold suitable for an engine and includes: a surge tank, die-molded to temporarily store intake air; and branch pipes, in communication with the surge tank. The surge tank includes: a boss part, having a cylindrical shape; and boss reinforcement ribs, extending in a direction toward a center of the boss part and connected with the boss part, the boss part and the boss reinforcement ribs being integrally formed on an outer wall of the surge tank.

### BRIEF DESCRIPTION OF THE DRAWINGS

FIG. 1 is a side view schematically illustrating an outboard motor in which an engine including an intake manifold according to an embodiment of the invention is mounted, and is a side view when the engine is partially cut off and viewed in a horizontal direction.

FIG. 2 is a plan view schematically illustrating the outboard motor in which the engine including the intake manifold according to an embodiment is mounted, and is a plan view in which the upper part of an engine cover is cut off and which is viewed from the upper side in the horizontal direction.

FIG. 3 is an appearance perspective view illustrating the intake manifold according to an embodiment, a throttle body connected with a surge tank, and a functional component, etc., when viewed obliquely in a direction.

FIG. 4 is an appearance perspective view illustrating the intake manifold according to an embodiment, the throttle body connected with the surge tank, and the functional component, etc., when viewed obliquely in another direction.

FIG. 5 is a front view illustrating the intake manifold according to an embodiment, the throttle body connected with the surge tank, and the functional component, etc., when viewed from an outer wall side of the surge tank.

FIG. 6 is a side view illustrating the intake manifold according to an embodiment, the throttle body connected with the surge tank, and the functional component, etc., when viewed from a side surface.

FIG. 7 is an exploded perspective view in which the intake manifold according to an embodiment, the throttle body, and the functional component are dissembled.

FIG. 8 is a front view illustrating the surge tank of the intake manifold according to an embodiment when viewed from the outer wall side.

FIG. 9 is a perspective view illustrating the surge tank of the intake manifold according to an embodiment when viewed obliquely in a direction.

FIG. 10 is a perspective view illustrating the surge tank of the intake manifold according to an embodiment when viewed obliquely in another direction.

FIG. 11 is a partially enlarged view illustrating a boss part and a boss reinforcement rib formed on the outer wall of the surge tank of the intake manifold according to an embodiment, together with a portion of a lattice-like reinforcement rib.

FIG. 12 is a perspective cross-sectional view illustrating the surge tank of the intake manifold according to an embodiment and taken along a surface passing through the boss part.

FIG. 13 is a partial perspective view illustrating a state before the nut is outserted to the boss part formed on the surge tank of the intake manifold according to an embodiment.

FIG. 14 is a partial cross-sectional view illustrating the state before the nut is outserted to the boss part formed on the surge tank of the intake manifold according to an embodiment.

FIG. 15 is a partial cross-sectional view illustrating a state after the nut is outserted to the boss part formed on the surge tank of the intake manifold according to an embodiment.

### DESCRIPTION OF THE EMBODIMENTS

An intake manifold according to an aspect of the invention is an intake manifold suitable for an engine and includes: a surge tank, die-molded to temporarily store intake air; and branch pipes, in communication with the surge tank. The surge tank includes: a boss part, having a cylindrical shape; and boss reinforcement ribs, extending in a direction toward a center of the boss part and connected with the boss part, the boss part and the boss reinforcement ribs being integrally formed on an outer wall of the surge tank.

In the electric device, it may also be configured that the surge tank includes a nut fixed to the boss part.

In the electric device, it may also be configured that the nut is outserted to the boss part.

In the electric device, it may also be configured that the boss reinforcement ribs are separated in a circumferential direction of the boss part to be disposed radially.

In the electric device, it may also be configured that at least a portion of the outer wall of the surge tank includes a plate-shaped outer wall formed in a plate shape, and the boss part and the boss reinforcement ribs are formed on the plate-shaped outer wall.

In the electric device, it may also be configured that a plate thickness of the boss reinforcement rib is equal to or less than a thickness of the boss part.

In the electric device, it may also be configured that the surge tank includes a lattice-like reinforcement rib formed integrally on the outer wall.

In the electric device, it may also be configured that the surge tank includes a lattice-like reinforcement rib formed integrally on the outer wall, and the boss reinforcement ribs are separated in a circumferential direction of the boss part to be disposed radially, and are connected with the lattice-like reinforcement rib.

In the electric device, it may also be configured that at least a portion of the outer wall of the surge tank includes a plate-shaped outer wall formed in a plate shape, and the boss part, the boss reinforcement ribs, and the lattice-like reinforcement rib are formed on the plate-shaped outer wall.

In the electric device, it may also be configured that the branch pipes include a first branch pipe module and a second branch pipe module each defining at least one branch passage, and the surge tank is formed in a cylindrical shape defining a first opening part and a second opening part on both ends, and includes: a first flange part, connected with the first branch pipe module on a periphery of the first opening part; a second flange part, connected with the second branch pipe module on a periphery of the second opening part; a third flange part, connected with a throttle body on a periphery of the inlet.

In addition, an outboard motor according to another aspect of the invention includes: an engine, having an intake system; a body, to which the engine is fixed; a propeller, rotated by a driving force of the engine; a functional component, having a predetermined function; and an engine cover, covering the engine. The intake system includes the intake manifold according to the above.

In the outboard motor, it may also be that the functional component is disposed in adjacency with the surge tank of the intake manifold, and the functional component is fastened and fixed to the boss part of the surge tank.

In the outboard motor, it may also be that the outer wall on which the boss part of the surge tank is formed extends in a vertical direction in a starting state of the engine.

According to the intake manifold with the above configuration, at the time of integrally die-molding the boss parts and the reinforcement ribs, a sink mark, etc., can be prevented from occurring, the mechanical strength can be secured, and, in particular, the nuts can be firmly fixed through outserting. In addition, by providing the intake manifold with such configuration, various functional components can be fixed to the intake manifold, and the outboard motor with high reliability can be provided.

In the following, the embodiments of the invention will be described with reference to the drawings.

An intake manifold according to the invention is die-molded by using a resin material, and is disposed between a throttle body and a cylinder head of an engine body, the throttle body being located downstream of an intake duct in an intake system of the engine. Here, as an embodiment, the case where the intake manifold is suitable for an engine of an outboard motor is described.

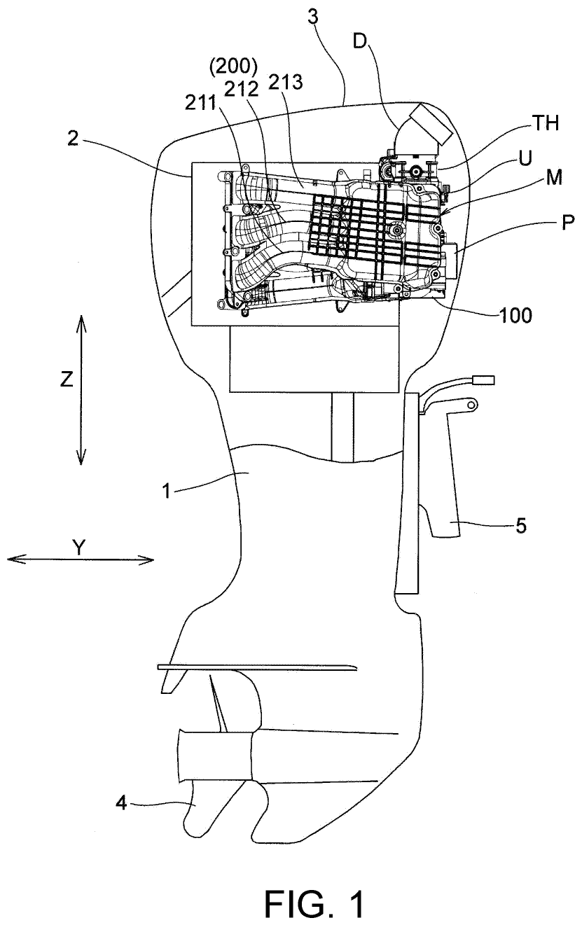

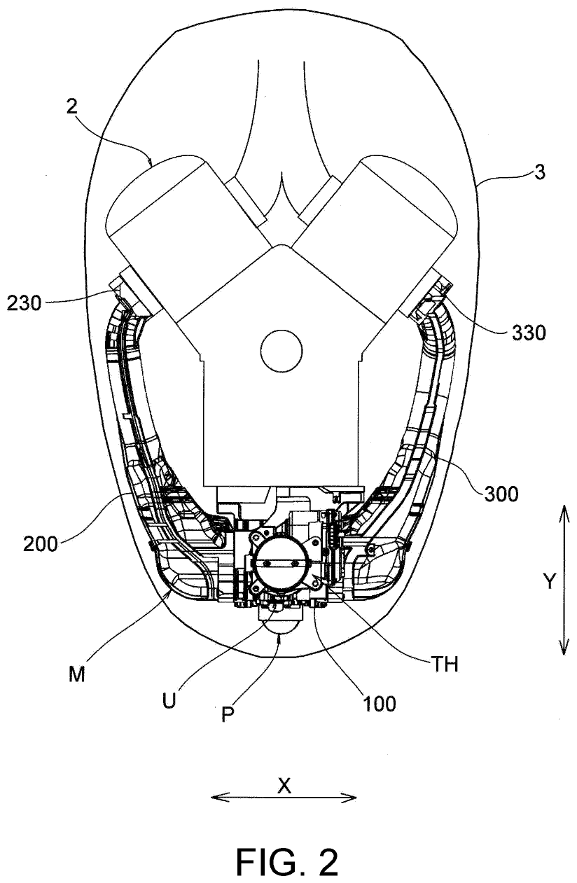

The outboard motor is a motor mounted to the rear part of a ship body to generate a propulsion force. As shown in FIGS. 1 and 2, the outboard motor includes a body 1, an engine 2 fixed to the body 1, an engine cover 3 covering the engine 2, a propeller 4 disposed below the body 1, a gasket 5 used at the time of being installed to the ship body, a functional component P having a predetermined function, a power transmission system disposed in the body 1 and transmitting power of the engine 2 to the propeller 4, and a fuel tank.

For the ease of description, the upright direction in which the outboard motor is mounted to the vehicle body is set as a vertical direction Z, the width direction of the outboard motor is set as a horizontal direction X, and the front-rear direction generating the propulsion force is set as a horizontal direction Y.

The engine 2 is a V-type six-cylinder internal combustion engine, and includes an engine body, an intake system, and an exhaust system. The engine body includes a cylinder block, a cylinder head, an oil pump, etc., and the intake system and the exhaust system are installed to the engine body.

The intake system includes an outside air introduction duct D, a throttle body TH, an intake manifold M, and a sensor unit U installed to the intake manifold M. Where necessary, the intake system may also include a resonator, a silencer, etc.

As shown in FIG. 1, in a state of being installed to the engine 2, the intake manifold is oriented so that three of six branch pipes are arranged in the vertical direction Z together. In a starting state of the outboard motor, i.e., the engine 2, a surge tank 100 of the intake manifold M is disposed so that the outer wall (outer side wall 110) of the surge tank 100 extends in the vertical direction Z.

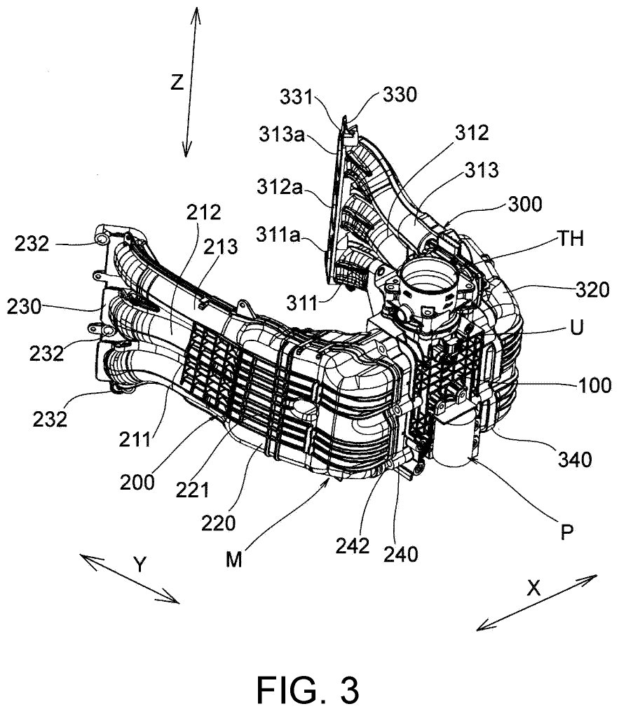

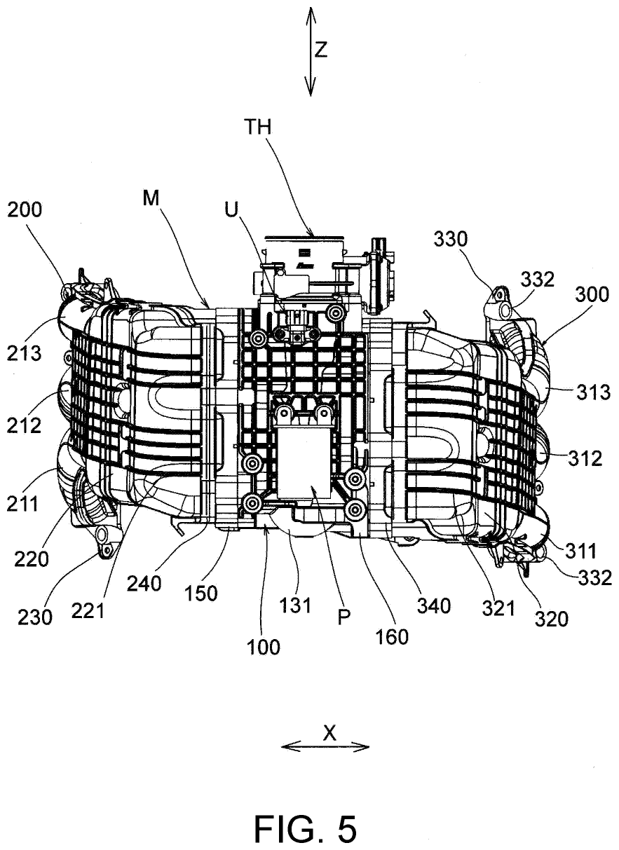

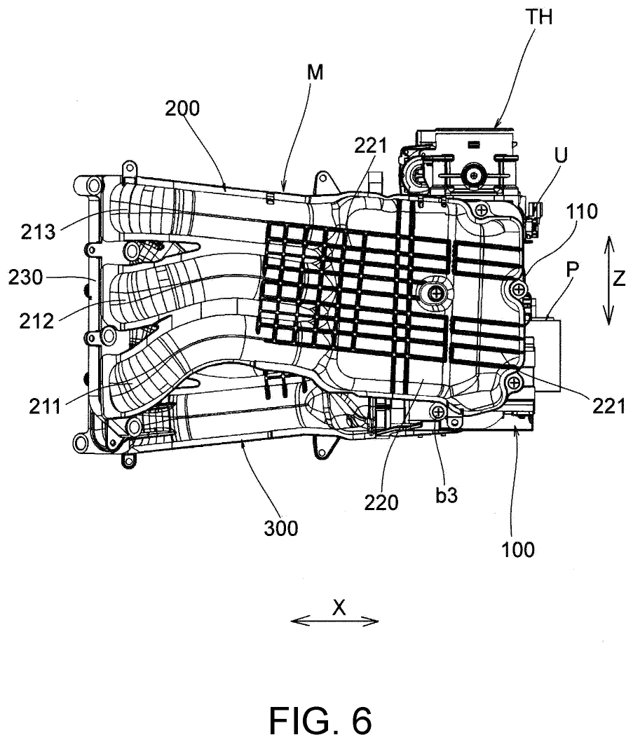

As shown in FIGS. 3 to 7, the intake manifold M is formed by: the surge tank 100, temporarily storing intake air; a first branch pipe module 200; and a second branch pipe module 300. In addition, in the intake manifold M, nuts N are fixed to boss holes h of multiple boss parts 111, 121, and collars C are fixed to multiple circular holes 122a.

The surge tank 100 is die-molded by using a resin material and formed in a cylindrical shape having an annular cross-section in a substantially rectangular shape to define a first opening part 100a and a second opening part 100b at two ends in the horizontal direction X and an internal space IS. In addition, the surge tank 100 includes an outer side wall 110, an inner side wall 120, a lower side wall 130, an upper low wall 140, a first flange part 150, a second flange part 160, an inlet 170, and a third flange part 180.

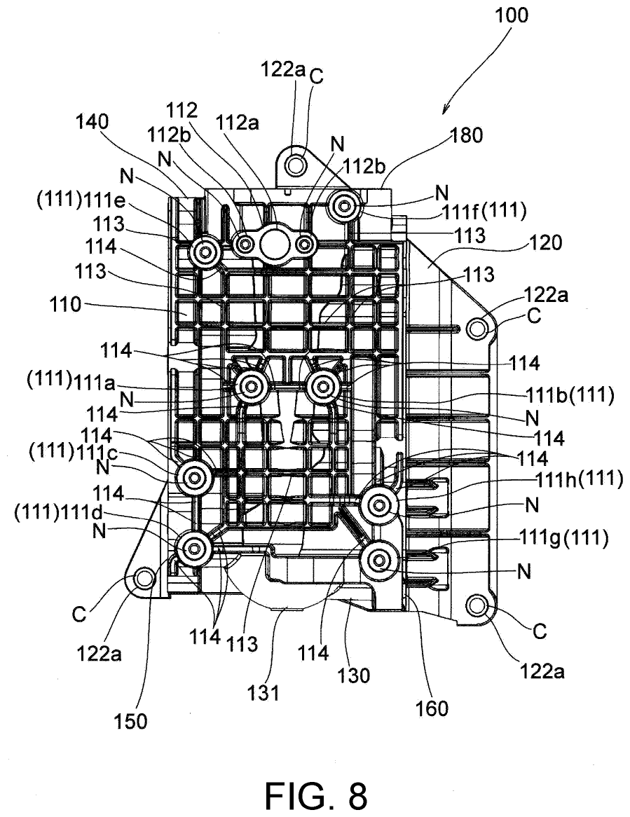

The outer side wall 110 forms a portion of the outer wall and is a plate-shaped outer wall formed in a plate shape to extend in the vertical direction Z in the starting state of the engine 2. As shown in FIGS. 8 to 10, the outer side wall 110 includes multiple boss parts 111 (111a, 111b, 111c, 111d, 111e, 111f, 111g, 111h), a flange part 112, a lattice-like reinforcement rib 113, and boss reinforcement ribs 114.

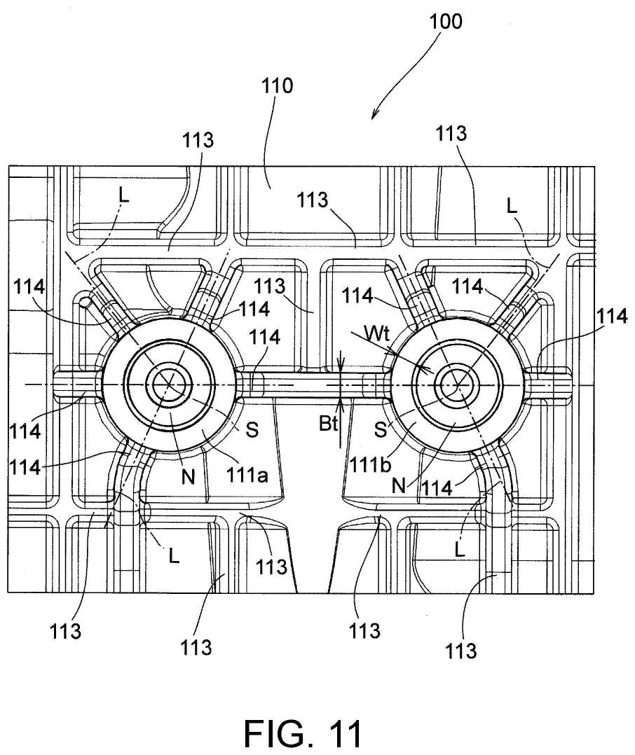

As shown in FIGS. 11 to 14, the boss part 111 protrudes from the wall surface of the outer side wall 110 and is formed in a cylindrical shape with an axis S as the center. On the inner side of the cylindrical wall with a thickness Wt, a boss hole h into which the nut N is outserted (fit) is defined. The boss hole h is formed as being slightly thinned toward the bottom. At the time when the nut N is outserted in a state of being heated, a portion of the inner wall of the boss hole h slightly melts to fit the profile of the nut N and then hardened.

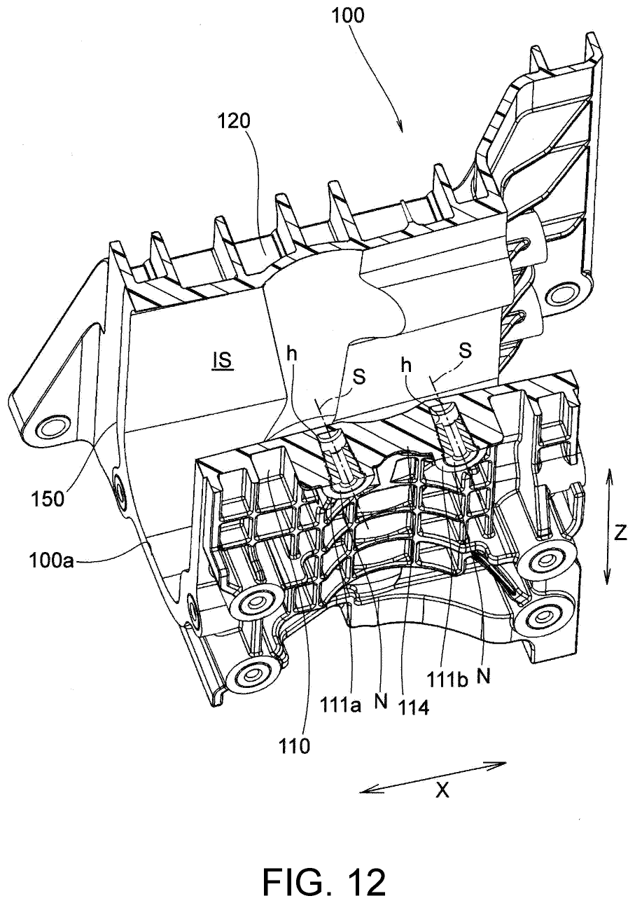

That is, as shown in FIG. 8, the boss parts 111a, 111b are located at the substantially center of the outer side wall 110, and, as shown in FIG. 12, the nuts N are fit into the respective boss holes h.

In addition, as shown in FIG. 8, the boss parts 111c, 111d are located at positions offset toward the lower side wall 130 on a side of the outer side wall 110, and the nuts N are fit into the boss holes h of the boss parts 111c, 111d. The boss part 111e is located at a position offset toward the upper side wall 140 on a side of the outer side wall 110, and the nut N is fit into the boss hole h of the boss part 111e. The boss part 111f is located at a position offset toward the upper side wall 140 on the other side of the outer side wall 110, and the nut N is fit into the boss hole h of the boss part 111f. The boss part 111g is located at a position offset toward the lower side wall 130 on the other side of the outer side wall 110, and the nut N is fit into the boss hole h of the boss part 111g. The boss part 111h is located at a position offset toward the lower side wall 130 on the other side of the outer side wall 110, and the nut N is fit into the boss hole h of the boss part 111h.

Here, the functional component P is fastened and fixed to the boss parts 111a, 111b by using bolts b1. Also, other functional components, such as a bracket fixing the engine cover 3, a component for electronic control, and other components, are fastened and fixed to the boss parts 111c, 111d, 111e, 111f, 111g, 111h by using bolts (not shown).

As shown in FIG. 8, the flange part 112 is located at a position offset toward the upper side wall 140 and at the substantial center of the outer side wall 110. The flange part 112 includes a circular hole 112a in communication with the internal space IS and two boss parts 112b, 112b. The nuts N are fixed to the two boss parts 112b, 112b, and the lattice-like reinforcement rib 113 is connected with the outer circumferential surfaces of the two boss parts 112b, 112b. The lattice-like reinforcement rib 113 extends in a direction toward the center of the boss part 112b to be connected, and functions as a boss reinforcement rib.

In addition, the sensor unit U is fastened and fixed to the flange part 112 by using the bolts b2.

The lattice-like reinforcement rib 113 forms a plate shape protruding vertically from the wall surface of the outer side wall 110, and is arranged in a lattice shape. In addition, by increasing the bending stiffness and the torsional stiffness, the lattice-like reinforcement rib 113 increases the overall surface stiffness, and increases the mechanical strength of the outer side wall 110.

The boss reinforcement ribs 114 mainly increase the stiffness of the boss parts 111 and form a plate shape protruding vertically from the wall surface of the outer side wall 110, and extend in a direction toward the centers (the axis S) of the boss parts 111 to be connected with the boss parts 111. In addition, in the boss reinforcement rib 114, a side opposite to the side connected with the boss part 111 is connected with the lattice-like reinforcement rib 113. The boss reinforcement rib 114 is formed to increase the overall stiffness.

Here, as shown in FIG. 11, a plate thickness Bt of the boss reinforcement rib 114 is formed in a dimension equal to or less than a thickness Wt of the boss part 111. In this way, by forming the plate thickness Bt to be equal to or less than the thickness Wt, at the time of cooling after die-molding, a sink mark where the inner wall surface of the boss hole h is recessed can be particularly prevented from being generated.

It is noted that the plate thickness of the lattice-like reinforcement rib 113 is formed to be the same as the plate thickness of the boss reinforcement rib 114.

In addition, as shown in FIG. 11, multiple (five herein) boss reinforcement ribs 114 are connected with the outer circumferential surface of each of the boss parts 111a, 111b. That is, the five boss reinforcement ribs 114 extend along lines L orthogonal to the center (the axis S) of the boss part 111a, 111b, that is, toward the center (the axis S) of the boss part 111a, 111b, to be connected, and are separated in the circumferential direction of the boss part 111a, 111b to be disposed radially.

In addition, as shown in FIG. 8, four boss reinforcement ribs 114 are connected with the outer circumferential surface of the boss part 111c, 111d. Here, like the above, the four boss reinforcement ribs 114 extend in a direction toward the center of the boss part 111c, 111d to be connected, and are separated in the circumferential direction of the boss part 111c, 111d to be disposed radially.

In addition, one of the boss reinforcement ribs 114 and a portion of the lattice-like reinforcement rib 113 are connected on the outer circumferential surface of the boss part 111e. Here, like the above, the one boss reinforcement rib 114 extends toward the center of the boss part 111e to be connected. Although the lattice-like reinforcement rib 113 extends in a direction slightly offset from the center of the boss part 111e to be connected, the lattice-like reinforcement rib 113 still functions as a reinforcement rib of the boss part 111e. In addition, the lattice-like reinforcement rib 113 and the boss reinforcement rib 114 are disposed to be separated from each other in the circumferential direction of the boss part 111e.

In addition, a portion of the lattice-like reinforcement rib 113 extends in a direction toward the substantial center of the boss part 111f to be connected to the outer circumferential surface of the boss part 111f. Since the boss part 111f is located in the vicinity of the upper side wall 140, the strength is sufficient even if there is no boss reinforcement rib 114, and the lattice-like reinforcement rib 113 also serves to provide reinforcement.

In addition, like the above, one of the boss reinforcements ribs 114 extends in a direction toward the center of the boss part 111g to be connected to the outer circumferential surface of the boss part 111g.
In addition, like the above, three of the boss reinforcement ribs 114 extend in a direction toward the center of the boss part 111h to be connected to the outer circumferential surface of the boss part 111h.

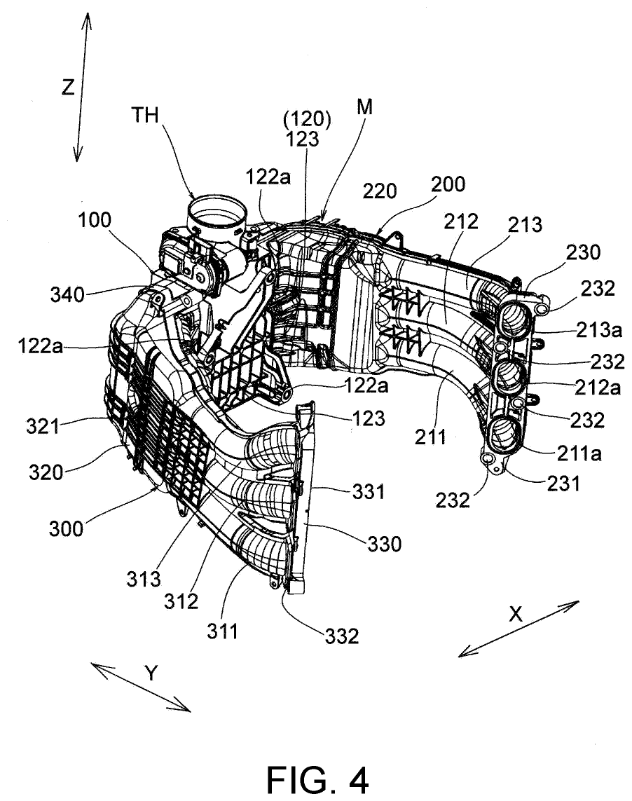

The inner side wall 120 forms a portion of the outer wall, and is formed to extend in the vertical direction Z and project in the horizontal direction X in the starting state of the engine 2. As shown in FIGS. 4, 9, and 10, the inner side wall 120 includes multiple boss parts 121 (121a, 121b, and 121b), a flange part 122, a lattice-shape reinforcement rib 123, boss reinforcement ribs 124, and reinforcement ribs 125.

The boss parts 121a and 121b are located at positions offset toward the lower side wall 130 in the projection part of the inner side wall 120, and the nuts N are fit into the boss holes h of the boss parts 121a and 121b.

The flange part 122 is formed at a projection part of the inner side wall 120, and includes four circular holes 122. Collars C are fixed to the circular holes 122a. In addition, the collars C are fixed through insertion or outsertion.

As shown in FIG. 4, the lattice-like reinforcement rib 123 forms a plate shape protruding vertically from the wall surface of inner side wall 120, and is disposed in a lattice shape. In addition, by increasing the bending stiffness and the torsional stiffness, the lattice-like reinforcement rib 123 increases the overall surface stiffness, and the mechanical strength of the inner side wall 120 is increased.

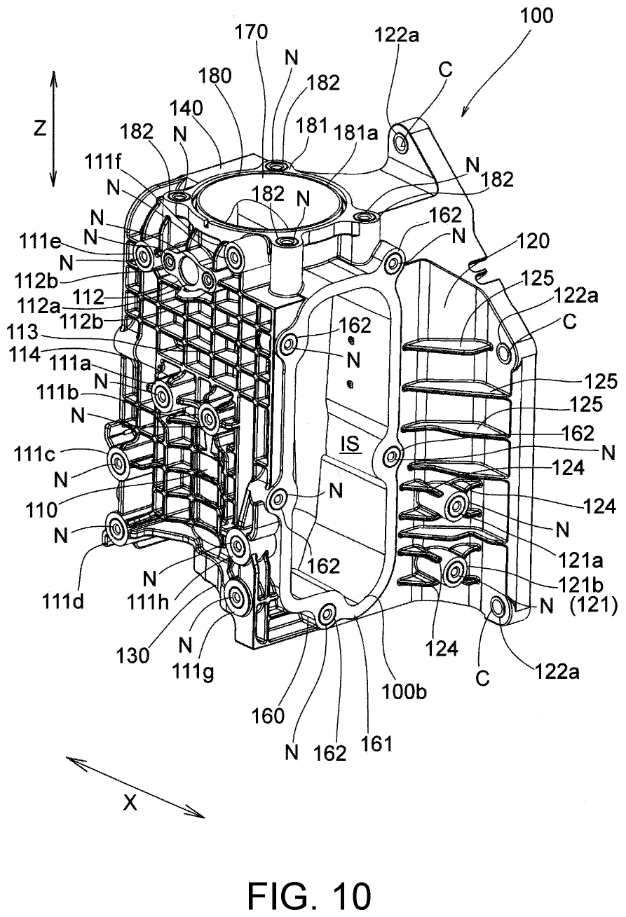

As shown in FIG. 10, the boss reinforcement ribs 124 increase the stiffness of the boss part 121a, 121b, form a plate shape protruding vertically from the wall surface of the projection part of the inner side wall 120, and are connected with the boss part 121a, 121b.

That is, the four boss reinforcement ribs 124 are respectively connected to the outer circumferential surface of the boss part 121a, 121b. Here, like the above, the four boss reinforcement ribs 124 extend in a direction toward the center of the boss part 121a, 121b to be connected, and are separated in the circumferential direction of the boss part 121a, 121b to be disposed radially. It is noted that a functional component, such as a stay supporting the intake manifold M, or other functional components are fastened and fixed to the boss parts 121a, 121b by using bolts (not shown).

As shown in FIG. 10, the reinforcement rib 125 increases the stiffness of the projection part of the inner side wall 120, and is formed in a plate shape that projects vertically from the wall surface.

The lower side wall 130 forms a portion of the outer wall, is disposed toward the lower side of the vertical direction Z in the starting state of the engine 2, is formed in a substantially plate shape expanding in the horizontal direction, and includes, in the central region thereof, a curved wall 131 curved to be convex toward the outer side. The curved wall 131 may be formed at a position opposite to the inlet 170 in the vertical direction Z.

The upper side wall 140 forms a portion of the outer wall, is disposed toward the upper side of the vertical direction Z in the starting state of the engine 2, and, defines, in the central region thereof, the inlet 170 and the third flange part 180 around the inlet 170.

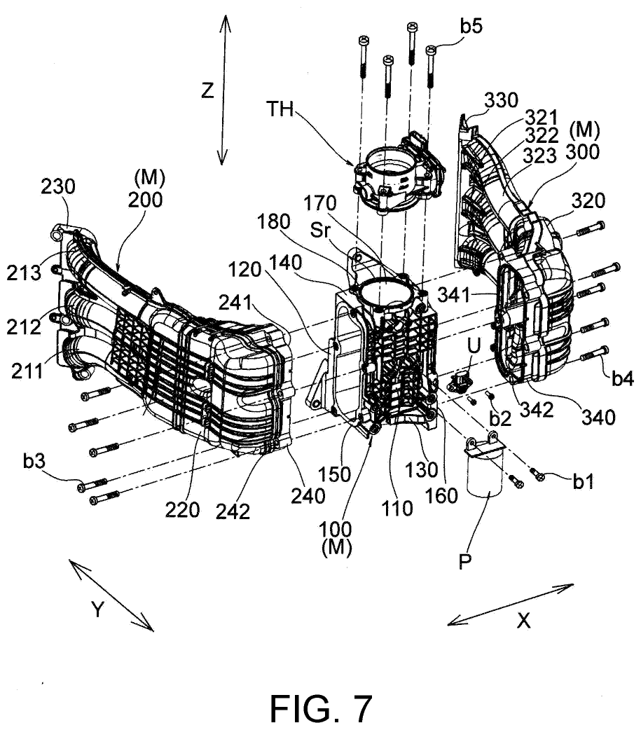

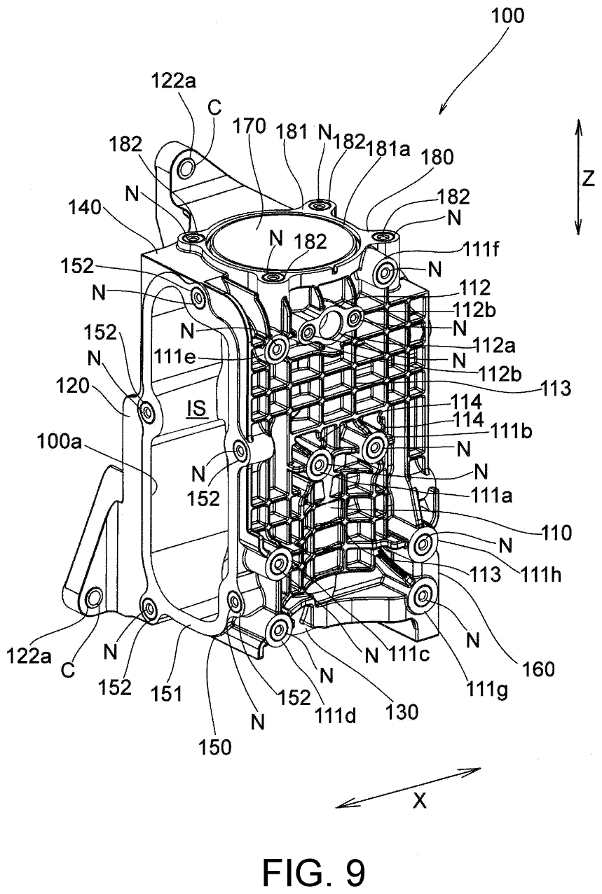

As shown in FIGS. 7 and 9, the first flange part 150 is formed to be annular around the first opening part 100a on a side in the horizontal direction X, and includes a bonding surface 151 bonded to the first branch pipe module 200, five fitting holes 152, and the nuts N fit into the fitting holes 152. The nuts N are fixed to the fitting holes 152 through outsertion.

As shown in FIGS. 7 and 10, the second flange part 160 is formed to be annular around the second opening part 100b on the other side in the horizontal direction X, and includes a bonding surface 161 bonded to the second branch pipe module 300, five fitting holes 162, and the nuts N fit into the fitting holes 162. The nuts N are fixed to the fitting holes 162 through outsertion.

The inlet 170 is a region where the intake air passing through the throttle body TH flows toward the internal space IS, and is formed as a circular opening toward the vertical direction Z in the starting state of the engine 2.

As shown in FIGS. 7, 9, and 10, the third flange part 180 is formed to be annular around the inlet 170, and includes a bonding surface 181 bonded to the throttle body TH, four fitting holes 182, and the nuts N fit into the fitting holes 182. The nuts N are fixed to the fitting holes 182 through outsertion. The bonding surface 181 includes an annular seal groove 181a to be fit with an annular seal member Sr.

The first branch pipe module 200 is formed by integrating two molded bodies die-molded by using a resin material. As shown in FIGS. 3 to 7, the first branch pipe module 200 includes three branch pipes 211, 212, 213, a collection duct part 220, a flange part 230, and a flange part 240.

The three branch pipes 211, 212, 213 are formed to each define branch passages 211a, 212a, 213a through which the intake air flows and in communication with three intake ports of a bank (cylinder row) on a side of the engine 2.

The collection duct part 220 has multiple reinforcement ribs 221 on the outer wall thereof, is formed upstream of the three branch pipes 211, 212, 213 to define an internal space, and is in communication with the internal space IS of the surge tank 100. That is, the collection duct 220 functions as a space for temporarily storing intake air, like the surge tank 100.

The flange part 230 serves to connect the three branch pipes 211, 212, 213 with each other and is bonded to the cylinder head of the engine 2, and includes a bonding surface 231 and four circular holes 232 through which fastening bolts (not shown) pass through.

The flange part 240 is bonded to the first flange part 150 of the surge bank 100, and includes a bonding surface including an annular seal groove to be fit with an annular seal member, and five circular holes 242 through which fastening bolts b3 pass through.

The second branch pipe module 300 is formed by integrating two molded bodies die-molded by using a resin material. As shown in FIGS. 3 to 5 and FIG. 7, the second branch pipe module 300 includes three branch pipes 311, 312, 313, a collection duct part 320, a flange part 330, and a flange part 340.

The three branch pipes 311, 312, 313 are formed to each define branch passages 311a, 312a, 313a through which the intake air flows and be in communication with three intake ports of a bank (cylinder row) on the other side of the engine 2.

The collection duct part 320 has multiple reinforcement ribs 321 on the outer wall thereof, is formed upstream of the three branch pipes 311, 312, 313 to define an internal space, and is in communication with the internal space IS of the surge tank 100. That is, the collection duct 320 functions as a space for temporarily storing intake air, like the surge tank 100.

The flange part 330 serves to connect the three branch pipes 311, 312, 313 with each other and is bonded to the cylinder head of the engine 2, and includes a bonding surface 331 and four circular holes 332 through which fastening bolts (not shown) pass through.

The flange part 340 is bonded to the second flange part 160 of the surge bank 100, and includes a bonding surface including an annular seal groove to be fit with an annular seal member and five circular holes 342 through which fastening bolts b4 pass through.

Then, a manufacturing and assembling process of the intake manifold M with the configuration is described.

Beforehand, the surge tank 100, the first branch pipe module 200, and the second branch pipe module 300 are respectively formed through die-molding by using a resin material.
At the time of assembling, the surge tank 100, the first branch pipe module 200, the second branch pipe module 300, the nuts N, the bolts b1, b2, b3, b4, and the annular seal member (not shown) are prepared.

Firstly, the nuts N are assembled to the boss parts 111 (111a, 111b, 111c, 111d, 111e, 111f, 111g, 111h) of the surge tank 100 through outsertion.

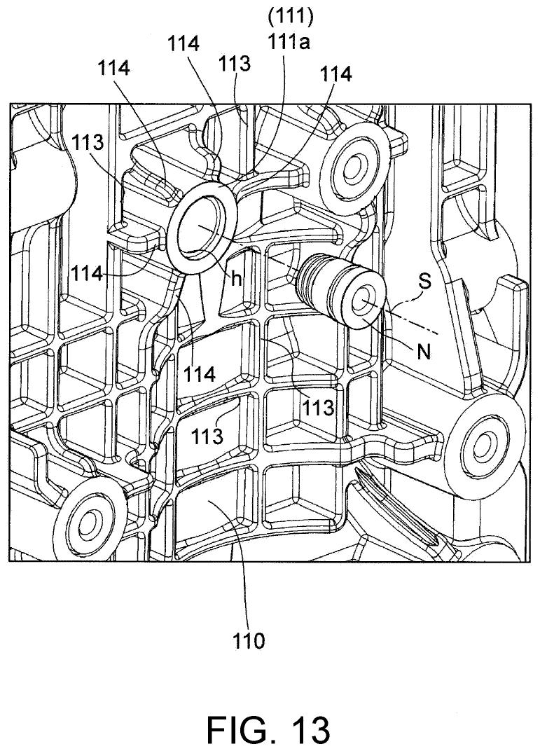

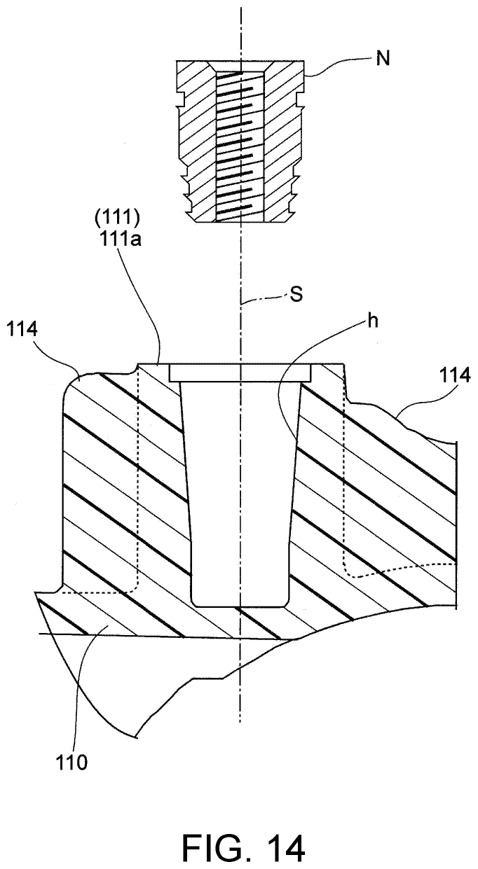

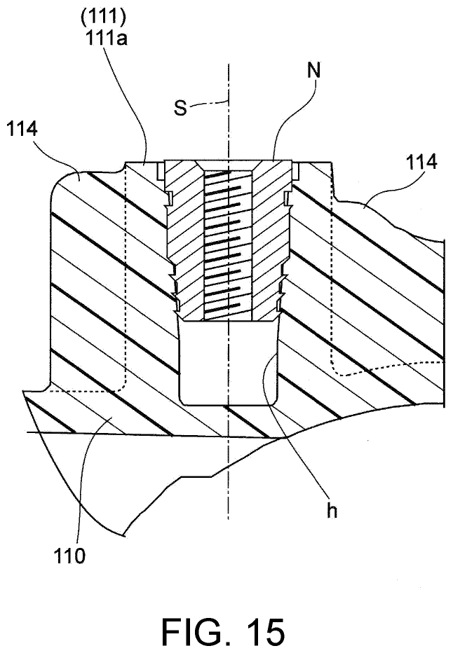

Specifically, as an example, a process of assembling the nut N to the boss part lila is as shown in FIGS. 13 to 15.
In a state of being heated to a predetermined temperature, the nut N is disposed to be opposite to the boss hole h of the boss part 111a, as shown in FIGS. 13 and 14.
Then, the nut N is pressed and fit into the boss hole h, as shown in FIG. 15. At this time, the inner wall part of the boss hole h partially melts to fit the profile of the nut N, and after being cooled down, the nut N is fixed to the boss hole h.

In the outsertion process, the boss part 111a is molded to a predetermined dimension without a sink mark, so the nut N can be firmly fixed to the boss part 111a.

The process of fitting the nut N as described above is performed on all of the boss parts 111b, 111c to h, 121a, 121b. The same process of fitting the nut N is also performed on the boss part 122b and the fitting holes 152, 162, 182.
In addition, the collars C are assembled to the circular hole 122a. The collars C are inserted together at the time of die-molding. Nevertheless, the collars C may also be outserted after die-molding.

Then, the first branch pipe module 200 and the second branch pipe module 300 are assembled to the surge tank 100.

Firstly, in the state in which the annular seal member is fit into the annular seal groove of the bonding surface 241, the flange part 240 of the first branch pipe module 200 is bonded to the bonding surface 151 of the first flange part 150 of the surge tank 100, and the bolts b3 are inserted into the circular holes 242 and screwed into and tightened with the nuts N fit into the fitting holes 152.

Then, in the state in which the annular seal member is fit into the annular seal groove of the bonding surface 341, the flange part 340 of the second branch pipe module 300 is bonded to the bonding surface 161 of the second flange part 160 of the surge tank 100, the bolts b4 are inserted into the circular holes 342 and screwed into and tightened with the nuts N fit into the fitting holes 162.

Accordingly, the assembling process of the intake manifold M is completed. It is noted that the order of assembling the first branch pipe module 200 and the second branch pipe module 300 merely serves as an example, and the components may also be assembled in a reversed order.

In addition, in the case where the intake manifold M is assembled as a portion of the intake air system of the engine 2, then, the throttle body TH is assembled to the third flange part 180 of the surge tank 100. That is, in the state in which the annular seal member Sr is fit into the annular seal groove 181a of the bonding surface 180 of the third flange part 180, the throttle body Th is bonded to the bonding surface 181, and the bolts b5 are screwed and tightened to the nuts N fit into the fitting holes 182.

In addition, the sensor unit U is bonded to the flange part 122, and the bolts b2 are screwed and tightened to the nuts N of the boss parts 112b.

In addition, the functional component P is disposed to be opposite to the boss parts 111a, 111b formed on the outer side wall 110 of the surge tank 100, and the bolts b1 are screwed and tightened to the nuts N fixed to the boss holes h.
Moreover, various functional components may be assembled to other boss parts 111 (111c, 111d, 111e, 111f, 111g, 111h, 121a, 121b) when necessary.

As described above, the intake manifold M according to an embodiment is an intake manifold suitable for the engine 2, and includes: the surge tank 100, die-molded to temporarily store intake air; and multiple branch pipes 211, 212, 213, 311, 312, 313, in communication with the surge tank 100. The surge tank 100 includes: the boss part 111, having a cylindrical shape, and integrally formed on the outer wall (the outer side wall 110) of the surge tank 100; and boss reinforcement ribs 114, extending in a direction toward the center of the boss part 111 and connected with the boss part 111.

Accordingly, the contact region between the boss reinforcement rib 114 and the boss part 111 can become narrow, and the boss part 111 can be reinforced by the boss reinforcement rib 114. Therefore, at the time of integrally forming the boss part 111 and the boss reinforcement rib 114 through die-molding, a sink mark, etc., can be prevented from occurring, and mechanical strength can be secured.

In addition, the surge tank 100 can have a configuration including the nuts N fixed to the boss parts 111.

Accordingly, after the surge tank 100 is formed through die-molding, the deformation of the boss part 111 is suppressed or prevented. Therefore, the boss hole h can be formed in a desired size, and the nut N can be fixed firmly.
In particular, through outsertion of the nuts N to the boss part 111, the nut N can be fixed through a simple process.

In addition, the boss reinforcement ribs 114 are formed to be separated in the circumferential direction of the boss part 111 to be disposed radially.

Accordingly, by increasing the intervals between the boss reinforcement ribs 114, the contact region with the boss part 111 can reduced, and the boss part 111 can be reliably reinforced.

In addition, at least a portion of the outer wall of the surge tank 100 includes a plate-shaped outer wall (outer side wall 110) formed in a plate shape, and the boss part 111 and the boss reinforcement rib 114 are formed on the plate-shaped outer wall (outer side wall 110). Accordingly, by integrally forming the boss reinforcement rib 114 connected on the periphery of the boss part 111, despite the outer wall is plate-shaped, the decrease in surface stiffness can be compensated by increasing the stiffness of the plate-shaped outer wall (outer side wall 110).

In addition, the plate thickness Bt of the boss reinforcement rib 114 is formed to be equal or less than the thickness Wt of the boss part 111.

Accordingly, at the time when the surge tank 100 is cooled off after die-molding, a sink mark where on the inner wall surface of the boss hole h of the boss part 111 is recessed can particularly be prevented from being generated.

In addition, the surge tank 100 is formed to include the lattice-like reinforcement rib 113 integrally formed on the outer wall (outer side wall 110).

Accordingly, the surface stiffness can be increased by increasing the bending stiffness and the torsional stiffness of the outer wall (outer side wall 110), and the overall mechanical strength of the surge tank 100 can be increased.

In addition, the surge tank 100 includes the integrally formed lattice-like reinforcement rib 113 on the outer wall (outer side wall 110), and the boss reinforcement ribs 114 are separated in the circumferential direction of the boss part 111 and disposed radially, and are formed to be connected with the lattice-like reinforcement rib 113.

Accordingly, the surface stiffness of the outer wall (outer side wall 110) can be increased, the stiffness around the boss part 111 can be increased, and the overall mechanical strength can be increased.

In particular, at least a portion of the outer wall of the surge tank 100 includes a plate-shaped outer wall (outer side wall 110) formed in a plate shape, and the boss part 111, the boss reinforcement rib 114, and the lattice-like reinforcement rib 113 are formed on the plate-shaped outer wall (outer side wall 110). Accordingly, despite the outer wall is plate-shaped, the decrease in surface stiffness can be compensated for, and the overall mechanical strength can be increased.

In addition, the branch pipes 211, 212, 213, 311, 312, 313 include the first branch pipe module 200 and the second branch pipe module 300 each defining at least one branch passage 211a, 212a, 213a, 311a, 312a, 313a. The surge tank 100 is formed in a cylindrical shape defining the first opening part 100a and the second opening part 100b on both ends, and includes: the first flange part 150 connected with the first branch pipe module 200 on the periphery of the first opening part 100a; the second flange part 160 connected with the second branch pipe module 300 on the periphery of the second opening part 100b; the inlet 170 through which the intake air flows in; and the third flange part 180, connected with the throttle body TH on the periphery of the inlet 170.

Accordingly, by forming the intake manifold M in three parts, molding becomes easy and, in particular, the die-molding of the surge bank 100 in which the boss parts 111 and the boss reinforcements rib 114 are integrally formed becomes easy.

In addition, the outboard motor with the above configuration includes: the engine 2 having the intake system; the body 1 to which the engine 2 is fixed; the propeller 4 rotated by the driving force of the engine 2; the functional component P having a predetermined function; and the engine cover 3 covering the engine 2. The intake system includes the intake manifold M according to the above.

In this way, by providing the intake manifold M having high mechanical strength in the intake system, a reliable outboard motor can be obtained.

In addition, the functional component P is disposed in adjacency with the surge tank 100 of the intake manifold M, and the functional component P is fastened and fixed to the boss parts 111a, 111b of the surge tank 100.

In this way, the surge bank 100 of the intake manifold M can be used to fix the functional component P, and, compared with a case where a dedicated fixing member is provided separately, the number of components of the outboard motor can be reduced.

In addition, the outer wall (outer side wall 110) where the boss parts 111 of the surge tank 100 are formed are formed to be disposed to extend in the vertical direction Z in the starting state of the engine 2.

In this way, in the case where the functional component P is fixed to the boss parts 111, even if the weight acts downward in the vertical direction Z on the functional component P or a bending stress or a shear stress is generated in the boss parts 111 due to vibration of the engine 2, as the mechanical strength is increased by the boss reinforcement ribs 114, the boss parts 111 can be prevented from being broken, and the initial function can be maintained.

According to the above, with the intake manifold M having the above configuration, at the time of integrally die-molding the boss parts 111 and the reinforcement ribs 114, a sink mark, etc., can be prevented from occurring, the mechanical strength can be secured, and, in particular, the nuts N can be firmly fixed through outserting. In addition, according to the outboard motor including the intake manifold having the above configuration, various functional components P can be fixed to the intake manifold M and the reliability can be increased, while the dedicated component for fixing can be omitted.

Although the above embodiment illustrates a configuration that the nuts N are outserted to the boss parts 111, the invention is not limited thereto. Other functional components may also be fit to the boss holes of the boss parts, and, particularly, in the case where an aluminum material is used, in place of resin material, for die-molding, female screws may also be formed through post-processing on the boss holes of the boss parts.

Although the above embodiment illustrates the case where the nuts N are fixed to the boss parts 111 through outsertion, the invention is not limited thereto. The nuts N may also be fixed through insertion.

In the embodiment, as the intake manifold, the intake manifold M formed by the surge tank 100, the first branch pipe module 200, and the second branch pipe module 300 is shown. However, the invention is not limited thereto. Intake manifolds of other separate configurations, or, if die-molding is possible, an intake manifold that is integrally molded as a whole may also be adopted.

As described above, according to the intake manifold of the invention, at the time of integrally die-molding the boss parts and reinforcement ribs, a sink mark, etc., can be prevented from occurring, and mechanical strength can be secured. In particular, since the nuts can be firmly fixed through outsertion, in addition to being applicable to the engine of the outboard motor, the intake manifold according to the invention is also applicable as the intake manifold of other engines.

What is claimed is:

1. An intake manifold, suitable for an engine, the intake manifold comprising:
a surge tank, die-molded to temporarily store intake air; and
a plurality of branch pipes, in communication with the surge tank,
wherein the surge tank comprises: a boss part, having a cylindrical shape; and boss reinforcement ribs, extending in a direction toward a center of the boss part and connected with the boss part, the boss part and the boss reinforcement ribs being integrally formed on an outer wall of the surge tank.

2. The intake manifold as claimed in claim 1, wherein the surge tank comprises a nut fixed to the boss part.

3. The intake manifold as claimed in claim 2, wherein the nut is outserted to the boss part.

4. The intake manifold as claimed in claim 1, wherein the boss reinforcement ribs are separated in a circumferential direction of the boss part to be disposed radially.

5. The intake manifold as claimed in claim 1, wherein at least a portion of the outer wall of the surge tank comprises a plate-shaped outer wall formed in a plate shape, and
the boss part and the boss reinforcement ribs are formed on the plate-shaped outer wall.

6. The intake manifold as claimed in claim 1, wherein a plate thickness of the boss reinforcement rib is equal to or less than a thickness of the boss part.

7. The intake manifold as claimed in claim 1, wherein the surge tank comprises a lattice-like reinforcement rib formed integrally on the outer wall.

8. The intake manifold as claimed in claim 1, wherein the surge tank comprises a lattice-like reinforcement rib formed integrally on the outer wall, and
the boss reinforcement ribs are separated in a circumferential direction of the boss part to be disposed radially, and are connected with the lattice-like reinforcement rib.

9. The intake manifold as claimed in claim 8, wherein at least a portion of the outer wall of the surge tank comprises a plate-shaped outer wall formed in a plate shape, and
the boss part, the boss reinforcement ribs, and the lattice-like reinforcement rib are formed on the plate-shaped outer wall.

10. The intake manifold as claimed in claim 1, wherein the branch pipes comprise a first branch pipe module and a second branch pipe module each defining at least one branch passage, and
the surge tank is formed in a cylindrical shape defining a first opening part and a second opening part on both ends, and comprises: a first flange part, connected with the first branch pipe module on a periphery of the first opening part; a second flange part, connected with the second branch pipe module on a periphery of the second opening part; an inlet, through which the intake air flows in; and a third flange part, connected with a throttle body on a periphery of the inlet.

11. An outboard motor, comprising:
an engine, having an intake system;
a body, to which the engine is fixed;
a propeller, rotated by a driving force of the engine;
a functional component, having a predetermined function; and
an engine cover, covering the engine,
wherein the intake system comprises the intake manifold as claimed in claim 1.

12. The outboard motor as claimed in claim 11, wherein the functional component is disposed in adjacency with the surge tank of the intake manifold, and
the functional component is fastened and fixed to the boss part of the surge tank.

13. The outboard motor as claimed in claim 12, wherein the outer wall on which the boss part of the surge tank is formed extends in a vertical direction in a starting state of the engine.
